(19) United States
(12) Patent Application Publication
(10) Pub. No.: US 2020/0285810 A1
(43) Pub. Date: Sep. 10, 2020

(54) SYSTEM AND METHOD FOR EXTRACTING INFORMATION FROM UNSTRUCTURED OR SEMI-STRUCTURED TEXTUAL SOURCES

(71) Applicant: App2Check S.r.l., Genova (GE) (IT)

(72) Inventors: Emanuele DI ROSA, Genova (GE) (IT); Andrea BONFIGLIO, Genova (GE) (IT); Massimo NARIZZANO, Genova (GE) (IT); Pierpaolo PEROTTO, Genova (GE) (IT)

(73) Assignee: App2Check S.r.l., Genova (GE) (IT)

(21) Appl. No.: 16/802,947

(22) Filed: Feb. 27, 2020

(30) Foreign Application Priority Data
Mar. 5, 2019 (IT) 102019000003139

(51) Int. Cl. G06F 40/279; G06N 20/00; G06N 5/00; G06N 5/04; G06F 16/23; G06F 40/30

(52) U.S. Cl. CPC G06F 40/279; G06N 20/00; G06F 40/30; G06N 5/04; G06F 16/2379; G06N 5/003

(57) ABSTRACT

A method for extracting and realizing from a non-structured or semi-structured textual source a Knowledge Base for chatbot having the phases of applying a process to the textual source is provided. The process has at least the phase of automatically finding “question” nodes in the textual source, and the phase having the sub-phases of: generating a representative tree of text nodes present in the textual source, extracting, by way of heuristics and/or a predictive model, certain features in the text node as the more recurring features and selectively attributing to the text nodes that comprise the most recurring characteristics, the “question” node feature, regardless of the fact that the text nodes have a question mark “?” among the extracted features. The invention also refers to a system arranged to implement the method.

### CROSS-REFERENCE TO RELATED APPLICATIONS

This application claims the benefit of Italian Patent Application No. 102019000003139, filed Mar. 5, 2019, the contents of which are incorporated herein by reference.

### FIELD OF INVENTION

The present invention relates, in general, to a system and method for extracting textual information from unstructured or semi-structured sources so as to obtain “Knowledge Base” or “KB” information that can be interrogated by expert “chat-bots” (KB for chatbot) in a specific knowledge domain stored on one or more computers.

### BACKGROUND OF THE INVENTION

Software packages configured to realize KB for chatbot are known.

Chat-bots arranged to interact in natural language with human beings, for example with customers or users, are also known.

Known chat-bots comprise, for example, virtual assistance software packages such as, for example, Cortana, Bixby, Google Assistant, Siri, etc., and are increasingly popular in the daily practice of using computers, whether they are portable devices or not.

The use of software packages to realize KB for chatbot and to realize chat-bots is also spreading in business and technical support for customer management.

In particular, as far as chat-bots are concerned, a recent Oracle study estimates that by 2020 chat-bots will integrate (if not replace) 80% of current customer management services.

In general, the creation of KB for chatbot and chat-bots involves a set of technical problems that cannot be easily overcome.

Taking into account that chat-bots may be seen as software packages able to entertain, in a completely automatic way, a fluid and “human” conversation with an interlocutor and that therefore they must pursue the final objective of making the chatbot user believing to interact with another human being, it is evident that chat-bots may operate correctly only if the software packages, that have realized the respective KB for chatbot, have worked correctly to identify the textual information comprised, for example, in unstructured or semi-structured textual sources.

The twofold problem of correctly creating KB for chatbot and chat-bots arranged to interact with KB for chatbot is not of an easy solution, even if in a context in which the need for “technical” chat-bots, that is software packages “shaped” so as to answer different questions on a specific topic, is very strong.

In particular, the knowledge bases or KB for chatbot, to which the present application refers, are not, as easily understandable by person skilled in the art, simple databases but are the result of textual information technical processing.

The most general problem related to the realization of KB for chatbot consists in interpreting and sectioning textual information so that it may be then managed by way of chatbot software packages.

The need to prepare various types of tools, also including Artificial Intelligence (AI) tools, to build KB for chatbot is strongly felt in the real world as these tools are the basis of the availability of virtual assistants that allow human beings to interact in natural language with computers.

In summary, the availability of virtual assistants arranged to understand textual information and to interact with human beings, at least within a certain domain of knowledge, is however a very felt need but requires, in any case, the construction of KB for chatbot based on textual information arriving, for example, from unstructured or semi-structured sources and comprising features that may be interpreted and managed by way of virtual assistants or chat-bots they are intended for.

For the sake of completeness, it is specified that a Knowledge Base for chatbot is intended, in the minimal version, as comprising at least one question example associated to an answer that can be questioned by the chatbot. The question example helps to contextualize when the associated answer needs to be provided.

The textual document (or a plurality of these), from which it is required to extract a Knowledge Base, is not always expressed in the form of question-answer pairs.

In case of FAQs, the presence of a question example represents the majority of cases (although not the totality as will be shown below).

In case of generic text documents, such as documents that describe products or services, the documents are structured in section titles and descriptive content thereof. In this case, to obtain a Knowledge-Base for chatbot, it is possible to consider, by analogy, the section title as a question example, and the content of the respective section as an answer associated to the question.

As far as the creation of KB for chatbot is concerned, a process of manually generating (FIG. 1), by way of a skilled operator, for example, a knowledge base (KB for chatbot) 110 starting from sources containing unstructured or semi-structured text information 105, such as WEB pages 101, pdf documents 102, and/or text documents, in general, is known.

It is also known, for example, from patent document US_2008/0046394_A, a method for extracting information from online discussion forums.

This known method provides for building a KB for chatbot with a certain order of relevance on the basis of structural and content features comprised in questions and answers stored by different users.

However, the known method shows at least the problem of requiring that user questions and answers are of high quality so as to avoid the risk of not being able to recognize and manage them correctly and of not being able to adequately manage the order of relevance of said questions and answers.

In summary, the known method, although limited to “threads” of online conversations, seems substantially inapplicable to textual information from unstructured or semi-structured sources and, in particular, to pairs of questions and answers typically present in many WEB sites in sections comprising FAQs (Frequently Asked Questions).

As a matter of fact, in the current practice, the contents of the FAQ, to which reference is preferably made hereinafter for convenience of description, do not have high quality structures whereby there is the problem of effectively extracting questions and answers in such a way that they can be interrogated, by expert “chat-bots” in a specific knowledge domain, stored on one or more computers.

Applicant has noted that an automatic or semi-automatic preparation of KB for chatbot, for example in the FAQ field, encounters some specific problems that are listed here, although not in an exhaustive way:
the questions and answers are not represented in different WEB sites in a single standard format since each WEB site is free to represent questions and answers in a personalized way;
some answers to specific questions can be repeated, so that the user should obtain, by using the corresponding virtual assistant, redundancy of identical answers starting from a single question;
the answers may internally comprise diversified hierarchical structures, for example subdivisions into sections and/or sub-sections, even due to the fact that they comprise or do not comprise other elements such as tables, bulleted lists, etc.

In summary, the problem that currently does not seem solved is that of extracting, automatically or semi-automatically from information generated by non-skilled users, high quality KB for chatbot that can be effectively used by respective virtual assistants or chat-bots.

As a matter of fact, the information generated by non-skilled users comprises non-homogeneous structures within different WEB sites or within the same WEB site and cannot be immediately and effectively used by a chat-bot due to their lack of homogeneity.

Applicant has therefore noted that in the real world the known art is not able to effectively solve the technical problem of the realization, in a completely automatic or semi-automatic way, of Knowledge Bases manageable by chat-bots (KB for chatbot) in case of basic textual information stored in an unstructured or semi-structured way such as, for example, in the context of the FAQ of one or more WEB sites or in the context of generic textual documents.

Applicant has also verified that state-of-the-art software tools, even made by leading companies in the field, are not able to extract in an exhaustive and error-free way both all the question-answer pairs present in a FAQ, and the content of textual documents by respecting the subdivision into sections and sub-sections of said documents.

### DETAILED DESCRIPTION OF THE INVENTION

Object of the present invention is to solve the problems of the known art in a substantially semi-automatic way.

Indeed, in the real world, the creation of KB for chatbot does not seem as if it can be solved with the implementation of mathematical algorithms only, but as if it preferably requires manual adaptation interventions so as to allow generalization of the manual interventions by way of automatic artificial intelligence algorithms and/or heuristics.

The system and method for extracting information from unstructured or semi-structured textual sources, as claimed, achieves the object.

The present invention also relates to a computer-readable medium comprising instructions executable by a computer for carrying out the method.

As used herein, the reference to a computer-readable medium is intended as equivalent to the reference to a computer-readable medium containing instructions for controlling a computerized system so as to coordinate the execution of the method according to the invention.

The reference to “a computer” or to a “computerized system” is intended to highlight the possibility that the present invention is implemented in a decentralized manner on a plurality of computers.

The following summary of the invention is provided in order to provide a basic understanding of some aspects and features of the invention.

This summary is not an extensive overview of the invention, and as such it is not intended to particularly identify key or critical elements of the invention, or to delineate the scope of the invention. Its sole purpose is to present some concepts of the invention in a simplified form as a prelude to the more detailed description that is presented below.

According to a feature of a preferred embodiment, the method for extracting and creating a Knowledge Base for chatbot starting from an unstructured or semi-structured textual source comprises, inter alia, a phase in which, by way of heuristics and/or an automatic predictive model, text nodes, comprising the feature of being definable as “question” nodes, are found into the text source.

According to a further feature of the present invention, the heuristics and/or predictive model are configured to identify, by analyzing the most recurrent features of the text nodes, the “question” node feature, regardless of whether these text nodes comprise a question mark “?” among the features extracted.

According to still a further feature of the present invention, the method comprises, inter alia, a phase in which the unstructured or semi-structured textual source is subdivided into sections and sub-sections.

According to another feature of the present invention, the method comprises, inter alia, a phase in which an operator, by way of a terminal, can intervene and modify the “question” nodes found.

According to yet another feature of the present invention, the modifications manually introduced may be automatically managed and extended to further text nodes having features similar to those of the modified nodes.

### BRIEF DESCRIPTION OF DRAWINGS

These and further features and advantages of the present invention will appear more clearly from the following detailed description of preferred embodiments, provided by way of non-limiting examples with reference to the attached drawings, in which components designated by same or similar reference numerals indicate components having same or similar functionality and construction and wherein:

FIG. 1 shows an example of a KB for chatbot according to the known art;

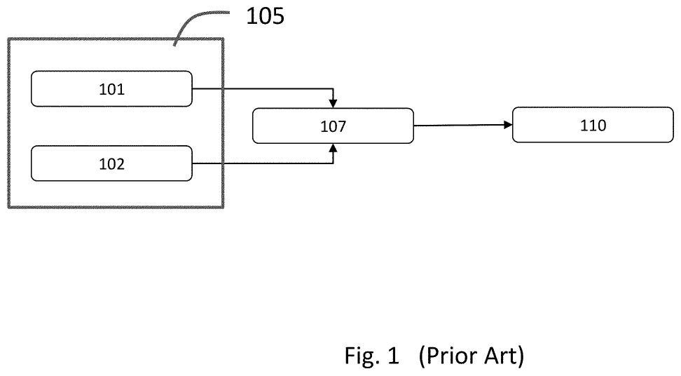

FIG. 2 shows a general block diagram of the process according to a preferred embodiment;

FIG. 3 shows a block diagram of a phase of the process of FIG. 2; and

FIG. 4 shows a general diagram of a system architecture that implements the process of FIG. 2.

### BEST MODES FOR CARRYING OUT THE INVENTION

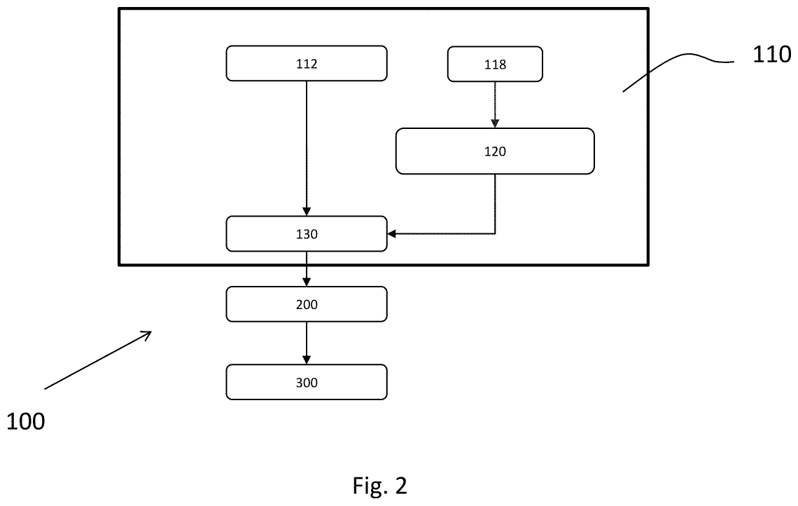

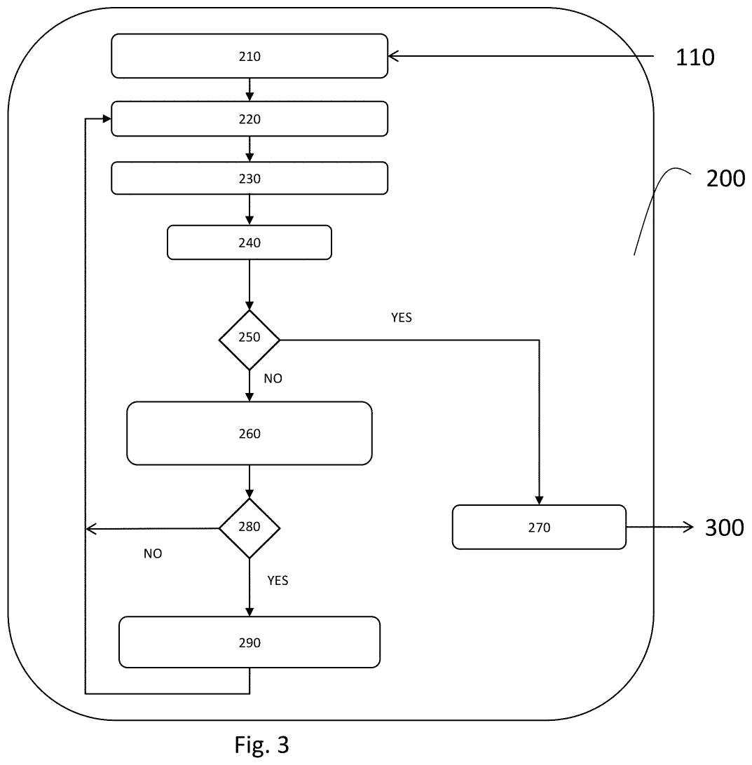

With reference to the FIGS. 2 and 3, a method or process for extraction and creation of a KB for chatbot (creation process of a KB) 100 is shown that starts from information originating from unstructured or semi-structured digital text sources; such information hereinafter is preferably called unstructured, and is originated, for example, from WEB sources 112, preferably in HTML code, or from PDF documents 118.

In the preferred embodiment it is provided that, in the event that the source of information is a PDF document 118, this document, before any processing, is converted, in a conversion step 120, into a file in HTML code 130, by way of tools of known type, so that the input 130 to the following steps is in any case a file in HTML code, that is taken here as a reference to exemplify the process.

Obviously, according to other embodiments, it is provided that the input file may also be in a different code, without thereby departing from the scope of what has been disclosed and claimed.

The process for creating the KB 100, after the preparation of the input file 130, comprises an extraction phase or process 200 and, in sequence, a storage phase of a KB for chatbot 300 wherein the KB for chatbot comprises structured information arranged to naturally interact with users within a certain knowledge domain by way of chat-bots.

For convenience of description, in the present exemplifying embodiment, an HTML code relating to a FAQ provided in the banking field is taken as input wherein the unstructured information to be transformed into structured information comprises questions, answers and sections diversified in respective questions and answers.

For completeness, it may be noted that in the present description, in the case of FAQ, the term “section” refers to a group of one or more pairs of questions and answers possibly organized hierarchically, and that each “section” is represented in the various tables of the following description as one or more continuous line rectangles.

Similarly, it may also be noted that in the following description, with the term “question” node/nodes, in the case of FAQs, reference is made to real questions while in the case of generic text documents, with the term “question” node/nodes reference is made to titles of sections or paragraphs.

According to the shown embodiment, the extraction process 200 comprises the following phases or sub-phases:
210—Use of heuristics/predictive model to automatically find “question” nodes;
220—Automatic division into sections, if sections are present;
230—Automatic extraction of section titles, if any, and answers;
240—Display of the result of phase 230;
250—Validation control by an operator wherein the output of the control may be:
   negative if manual changes are required to the file displayed in phase 240 (output NO);
   positive if manual changes to the file displayed in phase 240 are not required (output YES).

In case of the negative output (output NO) the following phases are provided:
260—manual changes made by an operator; and
280—automatic control on the type of changes made by the operator, whereby:
   in the positive case (output YES), i.e. in the event that the modifications made fall within a first specific modification type, the process proceeds with phase 290;
   in the negative case (output NO), i.e. in the event that the modifications fall within a second specific modification type, the process proceeds with phase 220.
   290—automatic classification of text nodes based on the classifications manually made by the operator during phase 260.

In case of a positive output from phase 250 (output YES), the extraction process 200 is completed by the phase:
270—completion of the extraction process 200 and activation of the phase 300.

In order to provide a greater detail of the main phases of the process 200, examples of pseudo-codes for the “automatic” phases 210, 220, 230 and 290 are given herein below.

```
Algorithm 1 Phase 210 - Question nodes identification
  function Phase210(nodes [symbol] )
    possibleQuestionNodes - QUESTIONNODESFILTERING(nodes [symbol] )
    stile ←MOSTRECURRENTSYLEEXTRACTION(possibleQuestionNodes)
    for all n in possibleQuestionNodes do
      if STYLE(n) = = style then
        n is a question
      end if
    end for
  end function
  function VALIDQUESTION(n)
    if at least one ? not included in links, parts of code etc. appears in the n node text then
      return true
    end if
    return false
  end function
  function QUESTIONNODESFILTERING(nodes [symbol] )
    result ← List
    for all n in nodes [symbol]  do
      if n contains a text and VALIDQUESTION(n) then
        add n to result
      end if
    end for
    return result
  end function
  function STYLE(n)
    return returns the set of style features of the node n
  end function
  function MOSTRECURRENTSYLEEXTRACTION(nodes)
    list_{styles} ← list, list_{counters} ← list
    for all n in nodes do
      stile ← STYLE(n)
      indice ← INDEXOF(list_{styles}, style)
      if indice ≥ 0 then
        INCREASECOUNTER(list_{counters}, indice)
      else
        APPEND(list_{styles}, style)
        APPEND(list_{counters}, 1)
      end if
    end for
    return GETATINDEX(MAN(list_{counters}))
  end function
```

[symbol]

indicates data missing or illegible when filed

### Phase 210

```
Algorithm 2 Phase 220 - Division into Sections
  function PHASE220(ques)
    DIVISIONINTOSECTINOS(null, Root(ques))
  end function
  function DIVISIONINTOSECTIONS(nₚ,nₙ)
    if TEXTNODESCOUNTER(nₙ) > 1 then
      if nₚ = = null or
        QUESTIONNODESCOUNTER(nₚ)>QUESTIONNODESCOUNTER(nₙ) then
        nₚ is a section node
      end if
      for all n_{d} in DESCENDANT(nₙ) do
        DIVISIONINTOSECTIONS(nₙ,n_{d})
      end for
    end if
  end function
  function TEXTNODESCOUNTER(n)
    if n is a text node then
      return 1
    end if
    result ← 0
    for all n_{d} in DESCENDANT(n) do
      result = result + TEXTNODESCOUNTER(n_{d})
    end for
    return result
  end function
  function QUESTIONNODESCOUNTER(n)
    if n is question node then
      return 1
    end if
    result ← 0
    for all n_{d} in DESCENDANT(n) do
      result = result + QUESTIONNODESCOUNTER(n_{d})
    end for
    return result
  end function
```

### Phase 220

```
Algorithm 3 Phase 230 - Automatic Extraction of Answer and Section Title
  function PHASE230(nodes_{ques})
    question_{current} ← null
    section_{current} ← null
    nodes [symbol]  ← null
    state_{current} ← 0
    for all i in 0:SIZE(nodes_{ques}) do
      n ← GETATINDEX(nodes [symbol] i)
      if state_{current} = = 0 then
        if n is a question then
          question_{current} ← n
          section_{current} ← SECTION(n)
          state_{current} ← 1
            nodes [symbol]  ← list
          end if
        else if state_{current} = = 1 then
          if n is in the same section as question_{current} then
            if n is a question then
              MERGEANSWER(question_{current}, nodes [symbol] )
              i = i − 1
              state_{current} = 0
            else if n is not to be discarded then
              APPEND(list, n)
            end if
          else if n is in a descending section of section_{current} then
            question_{current} is both a question and the title of section SECTION(n)
            section_{current} ← SECTION(n)
            i = i − 1
          else
            i = i − 1
            state_{current} ← 0
          end if
        end if
      end for
    end function
    function MERGEANSWER(node_{ques}, nodes [symbol] )
      if there is a n node such that:
        n is the ancestor of all nodes contained in nodes [symbol] )
        n contains only the nodes contained in nodes [symbol]  then
        n is the only answer node to the question node_{ques}
      else
        for all n in nodes [symbol]  do
          n is an answer node to the question node_{ques}
      end for
    end if
  end function
```

[symbol]

indicates data missing or illegible when filed

### Phase 230

```
Algorithm 4 Phase 290 - Semi-automatic classification prodcedure based on classifications per-
formed by the operator
  function PHASE290(nodes_{ques}, nodes [symbol] )
    map ← INITMAP
    for all n in nodes [symbol]  do
      style ← STYLE(n), classification ← CLASSIFICATION(n)
      PUT(style, classification)
    end for
    for all n in nodes_{ques} do
      if node n has never been classified by the user then
        style ← STYLE(n), classification ← GET(map, stile)
        if classification 1 = null then
          the node n should be classified as classification
        end if
      end if
    end for
  end function
  function CLASSIFICATION(n)
    return returns the current classification of the node n
  end function [symbol]
indicates data missing or illegible when filed
```

### Phase 290

According to the present description, the term pseudo-code, as easily understandable by a person skilled in the art, means a formal schematic representation that can be translated into any programming language.

For a better understanding of the extraction process or phase 200 provided in the process of creating a KB for chatbot 100, the phases and the elementary operations provided in the extraction process 200 are disclosed herein below in more detail by taking as a reference a realistic example realized starting from an unstructured FAQ.

The example shows how it is possible, through appropriate automatic algorithms and manual interventions interacting with the automatic algorithms, to identify, within a source of unstructured digital information, the different structured questions, answers and sections comprised in the unstructured digital information.

In the realistic example:

Phase 210 comprises at least the following elementary operations:

1. Parsing of the HTML code; and

2. Searching for “question” nodes.

Phase 220 comprises at least the elementary operation of dividing into sections, if any.

Phase 230 comprises at least the following elementary operations:

1. Extraction of section titles, if any, and of answers; and

2. Automatic merge of the answers.

The display phase 240 comprises software modules arranged to display the output of the application of automatic heuristics, for example, in phase 210 and of automatic algorithms or software packages in phases 220 and 230.

The control and validation phase 250 comprises operations that allow the operator to decide whether to accept what is displayed in phase 240 or, alternatively, whether to suggest new “question” nodes, based on the information in the document, and/or correct any classification emerged from what was displayed in step 240 of the extraction process 200.

The manual modification phase 260 comprises one or more of the following “elementary operations”:

a. forcing a manual classification of one or more nodes selected by the operator;

b. indication of one or more nodes comprising a margin for classifying other nodes;

c. manual merge of two or more consecutive text nodes;

d. split a node comprised of two or more text nodes;

e. elimination of an unnecessary division into sections; and

f. manual editing of the html code.

Phase 290 comprises the phase or procedure of semi-automatic classification based on the classifications performed by the operator.

Taking as a reference the realistic example and, in particular, phases 210, 220, 230, 260, 290, an example of execution of the respective elementary phases is disclosed herein below for each of the aforementioned phases.

### Phase 210

### 1. Parsing (Analysis) of the HTML Code

The elementary operations are exemplified starting from an unstructured or semi-structured information or page constructed here “ad hoc” for simplicity of description.

The page is shown in Table 1 as it should be displayed on a browser inside a FAQ as follows:

### Pin

What is the PIN?
The PIN code is the personal identification number assigned to the credit card that . . . ? . . .

I lost/forgot the pin code, can I have it back?
You can ask Customer Services to send the PIN to you.

### Security and Control Services

TABLE 1
Email Alert

Activating Email Alert service from your Personal Area ...

SMS Services

To activate SMS Service you must log into your Personal Area ...

The above text as shown in Table 1 may be obtained from the interpretation, by way of a BROWSER, of the following HTML code of Table 2:

```
. . .
<div>
  <b3>PIN</>
  <div>
    <div>
      <b>What is the PIN?</b>
      <p>The PIN code is the personal identification number assigned to the credit card that . . . ? . . .</p>
    </div>
    <div>
      <n>I lost/forgot the pin code, can I have it back?</b>
      <p>You can ask Customer Services to send the PIN to you.</p>
    </div>
  </div>
  <h3>Security and control services</h3>
  <div>
    <div>
      <b>Email Alert</b>
      <p>Activating Email Alert service from your Personal Area . . .</p>
    </div>
    <div>
      <n>SMS Services</n>
      <p>To activate SMS Service you must log into your Personal Area . . .</p>
    </div>
  </div>
</div>
. . .
```

The parsing operation preferably comprises the following two operations:

1—generation of a tree (DOM) like the one shown in Table 3 below;

2—searching for text nodes present within the DOM and assigning a numbering as shown in Table 3.

According to this description:
the expression “text nodes” refers to HTML elements in which there are no other HTML nodes but only text elements;
the second operation is carried out assuming that the display order of the text nodes match with the ordering within the corresponding HTML code.

### Wherein:

<div> Tag HTML that defines a division or section within an HTML page. The <div> element is often used as a container for other HTML elements with the aim both of assigning a style to all the HTML elements that compose it, and not of defining a semantic section.
<h3> Tag HTML used to define headers within an HTML page.
<b> Tag HTML used to display bold text.
<p> Tag HTML that defines a paragraph.
(k), (k+1), (k+3), . . . , (k+n) Pointers used to number the text nodes.

Once the tree (DOM) has been generated, preferably, on the basis of a predictive model, an extraction of semantic features (features) for each text node is performed and the features are reported in a table, here exemplified as Table 4, in which the pointers used to number the text nodes are applied to each text node.

The extraction of information may be performed by using a known library that simulates the opening of a browser, and then the uploading of files or documents formatted CSS (Cascading Style Sheets).

TAB 4

| Node | | | Font | Font | Font | Font | |
|---|---|---|---|---|---|---|---|
| # | ? | Pattern | Family | Size | Style | Weight | Color |
| k | no | ./div/div/h3 | Arial | 30px | normal | bold | rgb(0,0,0) |
| k + 1 | si | ./div/div/div/b | Arial | 20px | italic | bold | rgb(0,0,0) |
| k + 2 | si | ./div/div/div/p | Arial | 20px | normal | normal | rgb(0,0,0) |
| k + 3 | si | ./div/div/div/b | Arial | 20px | italic | bold | rgb(0,0,0) |
| k + 4 | no | ./div/div/div/p | Arial | 20px | normal | normal | rgb(0,0,0) |
| k + 5 | no | ./div/div/h3 | Arial | 20px | normal | bold | rgb(0,0,0) |
| k + 6 | no | ./div/div/div/b | Arial | 30px | italic | bold | rgb(0,0,0) |
| k + 7 | no | ./div/div/div/p | Arial | 20px | normal | normal | rgb(0,0,0) |
| k + 8 | no | ./div/div/div/b | Arial | 20px | italic | bold | rgb(0,0,0) |
| k + 9 | no | ./div/div/div/p | Arial | 20px | normal | normal | rgb(0,0,0) |

As easily understandable by a technician in the field, the extracted information may comprise additional features or attributes for each text node in addition to those provided here or may comprise less of it without thereby departing from the scope of what is disclosed and claimed.

According to the example shown here it results that, among the text nodes that here, in the concrete example, are assumed to be unstructured and therefore not classified, some text nodes:
are classified as questions, for example by highlighting that they include question marks “?” such as the nodes k+1, k+2, k+3;
are written with “bold” FONT (k, k+1, k+3, k+5, k+6, k+8);
comprise a certain color.

### 2. Searching for “Question” Nodes

According to the preferred embodiment, this elementary operation provides the implementation of a predictive model based on heuristic methodologies.

According to other embodiments, this elementary or sub-phase operation could be implemented by way of automatic learning methodologies such as for example recurrent neural networks (DEEP Recurrent Neural Networks) or other known automatic learning methodologies.

In the opinion of the Applicants, the use of a predictive model seems preferable since, as also apparent from the example, in realistic cases a question and an answer cannot be identified simply by the presence of a question mark “?” in the question. For this reason, the Applicants have decided to implement a heuristic method in the preferred embodiment, as clarified below.

According to the present embodiment, it is provided, for example, that in step 210 an automatic algorithm named “FilteringQuestionNoded” filters Table 4 by selecting only the rows having a question mark “?” inside the text node so as to provide the following Table 5.

TAB 5

| Node | | Font | Font | Font | Font | |
|---|---|---|---|---|---|---|
| # | Pattern | Family | Size | Style | Weight | Color |
| k + 1 | ./div/div/div/b | Arial | 20px | italic | bold | rgb(0,0,0) |
| k + 2 | ./div/div/div/p | Arial | 20px | normal | normal | rgb(0,0,0) |
| k + 3 | ./div/div/div/b | Arail | 20px | italic | bold | rgb(0,0,0) |

By analyzing Table 5, by way of a further automatic algorithm “ExtractingMoreRecurrentStyle” it is obtained that the most recurrent values comprise the characteristics shown in the following Table 6, in case of text nodes comprising a question mark “?”.

TABLE 6

| | Font | Font | Font | Font | |
|---|---|---|---|---|---|
| Pattern | Family | Size | Style | Weight | Color |
| ./div/div/div/b | Arial | 20 px | italic | bold | rgb(0,0,0) |

Having identified the most recurring features of the text nodes as highlighted in Table 6, it is possible, by way of yet another algorithm, to automatically filter the Table 4 by using the characteristics or features of Table 6.

It follows that it is possible to implement in the heuristic model an algorithm that recognizes the characteristic “question” node to the text nodes k+1, k+3, k+6 and k+8 as shown in the following Table 7.

TAB 7

| Node | | | Font | Font | Font | Font | |
|---|---|---|---|---|---|---|---|
| # | ? | Pattern | Family | Size | Style | Weight | Color |
| k | no | ./div/div/h3 | Arial | 30px | normal | bold | rgb(0,0,0) |
| k + 1 | si | ./div/div/div/b | Arial | 20px | italic | bold | rgb(0,0,0) |
| k + 2 | si | ./div/div/div/p | Arial | 20px | normal | normal | rgb(0,0,0) |
| k + 3 | si | ./div/div/div/b | Arial | 20px | italic | bold | rgb(0,0,0) |
| k + 4 | no | ./div/div/div/p | Arial | 20px | normal | normal | rgb(0,0,0) |
| k + 5 | no | ./div/div/h3 | Arial | 30px | normal | bold | rgb(0,0,0) |
| k + 6 | no | ./div/div/div/b | Arial | 20px | italic | bold | rgb(0,0,0) |
| k + 7 | no | ./div/div/div/p | Arial | 20px | normal | normal | rgb(0,0,0) |
| k + 8 | no | ./div/div/div/b | Arial | 20px | italic | bold | rgb(0,0,0) |
| k + 9 | no | ./div/div/div/p | Arial | 20px | normal | normal | rgb(0,0,0) |

By comparing Tables 4 and 5 with Table 7, it is apparent that the text node k+2 is discarded as a possible “question” node and that the “question” node feature is instead also attributed, as shown in Table 7, to nodes k+6 and k+8, that do not comprise in the unstructured information a question mark.

### Phase 220

Once the questions have been identified, phase 220 comprises the task of identifying and grouping, according to the realistic example provided here, the identified questions into sections, if any.

Table 8 shows the result of the operations carried out by phase 220 as regards the realistic example utilized herein, in which it is provided in any case the presence of sections.

### Wherein:

parts enclosed in rectangles made of continuous lines relate to sections and parts enclosed in rectangles made of dotted lines relate to questions.

### Phase 230

1. Extraction of Section Titles, if any, and Answers

The automatic algorithm for extracting answers and section titles allows to extract the answers and possibly classify some “question” nodes as “section titles” based on both the results obtained in phases 210 and/or 220 and on the structure of the HTML document as shown in the following Table 9.

According to the preferred embodiment and to the realistic example shown herein, it is provided that the algorithm performs the following operations:
scrolling through all the text nodes and all the sections found in Table 8 sorted in the order in which the DOM tree is visited;
numbering the sections found or identified in ascending order;
numbering the questions in ascending order;
recognizing if a question is to be considered as a section title; and
by using the questions and the sections found as delimiters, assigning to each question an answer (if any) in which each answer node comprises a direct correspondence with a respective question node and assumes the same id as shown in Table 9.

The basic operation 1. allows to generate a direct correspondence between question/s and answer/s whereby, preferably, each “answer node” will comprise the same id as the question that generated it.

2. Automatic Merge of Answers

The “automatic merge” operation is an optional operation provided in phase 230 when the answer nodes are very complex.

In such cases it is preferably appropriate not only an algorithm for extracting the text nodes but also an algorithm for extracting the HTML structure of the answer nodes.

An example of a text different from that analyzed in Tables 1 and 2 and comprising, for example in the FAQ, unstructured and articulated answers, is exemplified in the following Table 10.1 and 10.2.

TABLE 10.1
. . .
Which are minimum system requirements?

| | |
|---|---|
| Minimum | Recommended |

| | | | | |
|---|---|---|---|---|
| Ram | 4 | Gb | 8 | Gb |
| Hard drive | 10 | Gb | 15 | Gb |

. . .

which in HTML language may correspond to the following content:

TAB 10.2

```
. . .
<div>
  <span>Which are minimum system requirements?</span>
  <table>
    <tr>
      <tr></tr>
      <td>Minimum</td>
      <td>Recommended</td>
    </tr>
    <tr>
      <td>Ram</td>
      <td>4 Gb</td>
      <td>8 Gb</td>
    </tr>
    <tr>
      <td>Hard drive</td>
      <td>10 Gb</td>
      <td>15 Gb</td>
    </tr>
  </table>
</div>
. . .
```

In this case the “automatic merge” operation allows to convert the DOM tree as predictable before the “automatic merge” operation and highlighted in the following Table 11.1 to the following Table 11.2 as expected after the “automatic merge” operation.

### Wherein:

the symbology comprised in a hexagon represents the HTML element comprising the question;
the symbology comprised in a triangle represents the HTML element comprising the answer or part of it.

As shown in Table 11.2, the “automatic merge” operation or algorithm has recognized in the new sentence reported in Table 10.1 the presence of a question <span> and its corresponding answer not as the set of all <td> nodes but as a single <table> node containing the entire structure of the answer/s.

According to the preferred embodiment, it is provided that in the control and validation phase 250 the operator may cancel the basic “automatic merge” operation and may accept, through the use of a pop-up menu, a structure of questions and answers that do not bring into consideration the basic “automatic merge” operation; in this case the operation is named here “split” operation.

Once phase 230 is completed, if the operator finds in phase 240 that the automatic algorithms or operations have not correctly or completely extracted the information related to the FAQ's questions and answers, it is provided that phase 260 will be activated in order to perform one or more manual operations.

### Phase 260

Taking as reference the text shown below in Table 12 that, for example, may represent the result displayed in step 240 of the automatic operations carried out in steps 210, 220 and 230 on the text of Tables 1 and 2, the operator, for example through a pop-up menu, may perform the following manual operations.

a. Manual Classification of a Node

The operator may select one or more text nodes and change their classification. When a node is manually classified, the process can no longer change its classification, for example, in the following step 290.

b. Indication of One or More Nodes with a Margin for Classifying Other Nodes

Still referring back to the text shown in Table 12, the operator, for example by way the same pop-up menu or an additional menu, can click on the “Pin” node and modify its classification by selecting a “semi-automatic” mode, i.e. a non-forcing mode.

In this case, the process 200 will automatically classify in the same way all the nodes similar to those selected by the operator.

TABLE 13.1

| | Font | Font | Font | Font | |
|---|---|---|---|---|---|
| Pattern | Family | Size | Style | Weight | Color |
| ./div/div/h3 | Arial | 20 px | normal | bold | rgb(0,0,0) |

According to the present embodiment, the identified features allow to automatically consider the nodes having the same features in the same way as the node classified in semi-automatic mode, for example, as a “question” node.

In particular, in the exemplified case, if the operator classifies the “Pin” node as a “question” node in semi-automatic mode, the process 200 in phase 290 will proceed, for example, to automatically classify also the “Security and Control Services” node as a “question” node.

This process behavior is based on the fact that the features highlighted in Table 13.1 herein below are recognized in the “Pin” node and that these are used to automatically classify also the “Security and Control Services” node.

Table 13.2 shows the result obtained in phase 240 compared to the semi-automatic classification of the text node “Pin”. In phase 230, the system detects that the “Pin” and “Security and control services” nodes, in addition to be “question” nodes, are also titles of sections 2 and 3.

c. Manual Merge of Two or More Consecutive Text Nodes

The operator may select one or more nodes and decide to perform a “manual merge” operation in order to collect a plurality of unrecognized answers in the automatic phase 210 as answers to a single question.

By way of manual commands carried out, for example, with additional pop-up menus, the same procedure, as disclosed in elementary operation 2. provided in phase 230, will be applied.
d. Split of a Node Comprising Two or More Text Nodes

In the following example shown in Table 14.1, it may be noted the need to divide the “answer node” as there are subsections inside the answer.

In this case, it is expected that the operator may divide the answer node into several sections with manual commands, for example by way of a pop-up menu, and obtain the result highlighted in Table 14.2.

TABLE 14.1

[symbol]

You can activate SMS services from your Private Customer Personal Area
SMS security service - Movements Notice
Activating Next SMS Security Service - Movements Notice (SMS Alert), you will always have the possibility
to keep track of your expenses with Card for free
Its operation is very simple [symbol] every time you pay with Next for 200 euros or more, you receive a free SMS. If
something doesn't add up, call Customer Service: in case of any misuse, charge and Card will be blocked.
Informative SMS Service
You can customize the amount activating the Informative SMS Service which allows to be informed for
each payment order of less than 200 euros made on your Card
The service can be requested only after the activation of the SMS security service - Movement Alert
through Customer Service or by accessing the Portal, choosing the minimum amount of transactions for
which to receive SMS (not less than 50 euros).
The activation of the SMS Information Service includes a year fee.
Functional SMS Service
With Functional SMS Service you can request information via SMS about latest transactions, card balance,
remaining card availability, #lost balance and much more. This way, you'll always have all the information at
your fingertips.
For further information see the SMS Regulation and the information sheets in the Transparency area. [symbol]
indicates data missing or illegible when filed

In the exemplified case, for example, the nodes “SMS Security Service—Movement Notice”, “SMS Informative Service” and “Functional SMS Service” have been comprised in the FAQ with dimensions and type of font having characteristics different from those provided for other services whereby in phase 210 the automatic algorithm, for example, was not able to identify the question and answer sub-sections and consequently an intervention by the operator in phase 260 was necessary before proceeding with a new activation of the phase 220 according to the results of phase 280.

e. Deletion of a Split into Sections

Within the HTML code there may be markup TAGS exclusively provided for a matter of style that could interfere with the extraction process. These TAGS may generate a new incorrect subsection. By way of this manual command, the operator is able to delete these TAGS.

In this case, the operator, manually, for example through a pop-up menu, may eliminate any further split in sub-sections as highlighted in the example shown in Table 15 below wherein the section that comprises the first two questions should be deleted. Following the intervention of the operator to delete the section which includes the two questions, the phase provided in step 260 returns to steps 220, 230, 240 which automatically perform the automatic procedure for searching questions and answers and dividing them into sections, if present, by taking into account the intervention of the operator.

Advantageously, thanks to a single manual intervention, the process correctly reconstructs questions, answers and sections, if any, thanks to the fact that the process uses a heuristic methodology.

f. Manual Editing of the HTML Code

Within the HTML source code there may be errors or faults that can be corrected only by manually manipulating the source HTML code.

### Phase 290

As previously reported and exemplified, in the event of a classification operation of a text node carried out in semi-automatic mode, an automatic algorithm will be performed which is able to find further nodes having the same features as that classified in semi-automatic mode. According to this embodiment, it is expected that this algorithm cannot in any way change the classification of one or more nodes explicitly assigned by the operator.

According to other embodiments, phase 290 could be implemented with automatic learning methodologies.

The process for creating a KB for chatbot has been exemplified until now by referring to HTML codes relating to FAQs.

Applicant however has noted that the process is also applicable to text documents wherein there are not provided questions and answers but there are provided sections that relate to the hierarchical organization of one or more documents.

An example of application of the process, disclosed until now, applied to an unstructured or semi-structured textual document is given below. In particular, an example of an HTML page extracted from WIKIPEDIA under “Questions and answers” is shown in Table 16.1.

```
TABLE 16.1
Questions and answers
From Wikipedia, the free encyclopedia
Questions and answers (sometimes shortened to Q&A) may refer to
  • Questions and Answers (TV series), a topical debate television programme in Ireland
  • Questions and Answers (TV Channel), a Russian television channel, only gameshows.
  • “Questions and Answers” (The Golden Girls), a 1992 TV episode
  • Google Questions and Answers
Music (edit)
  • “Questions and Answers” (Nektar song), a song from the 1973 Nektar album Remember the Future
  • “Questions and Answers” (Sham 69 song), a song from the 1979 Sham 69 album The Adventures of the Hersham Boys
  • Questions and Answers (album), a 1989 jazz album by Pat Metheny, Dave Holland and Roy Haynes
  • “Questions and Answers” (Biffy Clyro song), a song from the 2003 Biffy Clyro album The Vertigo of Bliss
  • Questions & Answers (album), a 2006 album by The Sleeping
See also (edit)
  • Q&A (disambiguation)
  • Frequently asked questions
```

| | |
|---|---|
| [symbol] | This disambiguation page lists articles associated with the title Questions and answers. |
| | If an internal link led you here, you may wish to change the link to point directly to the intended article. |

As may seem apparent to a person skilled in the art, the text is descriptive of the meaning of the expression “Questions and answers”.

Given the application of the process of creating a KB for chatbot 100 and in particular of the extraction process 200 as disclosed, it was possible to obtain what is reported in the following table 16.2.

```
TABLE 16.2
Questions and answers

[symbol]

[symbol]


Questions and answers (sometimes shortened to Q&A) may refer to
  • Questions and Answers (TV series), a topical debate television programme in Ireland
  • Questions and Answers (TV Channel), a Russian television channel, only gameshows.
  • “Questions and Answers” (The Golden Girls), a 1992 TV episode
  • Google Questions and Answers
Music [symbol]
  • “Questions and Answers” (Nektar song), a song from the 1973 Nektar album Remember the Future
  • “Questions and Answers” (Sham 69 song), a song from the 1979 Sham 69 album The Adventures of the Hersham Boys
  • Questions and Answers (album), a 1989 jazz album by Pat Metheny, Dave Holland and Roy Haynes
  • “Questions and Answers” (Biffy Clyro song), a song from the 2003 Biffy Clyro album The Vertigo of Bliss
  • Questions & Answers (album), a 2006 album by The Sleeping
See also [symbol]
  • Q&A (disambiguation)
  • Frequently asked questions
Disambiguation page providing links to topics that could be referred to by the same search term
This disambiguation page lists articles associated with the title Questions and answers.
If an internal link led you here, you may wish to change the link to point directly to the intended article.
Retrieved from [symbol]
Categories:
  • Disambiguation pages
Hidden categories
  • Disambiguation pages with short description
  • All article disambiguation pages
  • All disambiguation pages [symbol]
indicates data missing or illegible when filed
```

By comparing table 16.1 with table 16.2 it is clear that the extraction process 200, applied to a structure not ascribable to that of a FAQ, has allowed to extract all the information present in the HTML page.

In particular, the “structured” text of Table 16.2 was obtained from the “unstructured” text of Table 16.1 by way of the following phases:
activation of a single iteration of the process 200;
execution of two manual interventions in phase 260 by semi-automatic classifying as “question” node the “Music” node and by deleting the “[edit]” node;
execution of two manual interventions in the manual classification phase 260 wherein the “Questions and Answers” node has been classified as “question” node, while the “From Wikipedia, the . . . to search” node has been deleted or discarded.

In general, it is possible to apply the present embodiment to a textual document, such as for example a book comprising section titles and paragraphs.

In case of a generic text document, there are no, as easily understandable by a technician in the field, “question” nodes, while there is generally a hierarchy of section titles, in which the more detailed section or leaf corresponds, according to this embodiment, to a “question” node and the answer corresponds to the paragraph associated to the respective section title or “question” node.

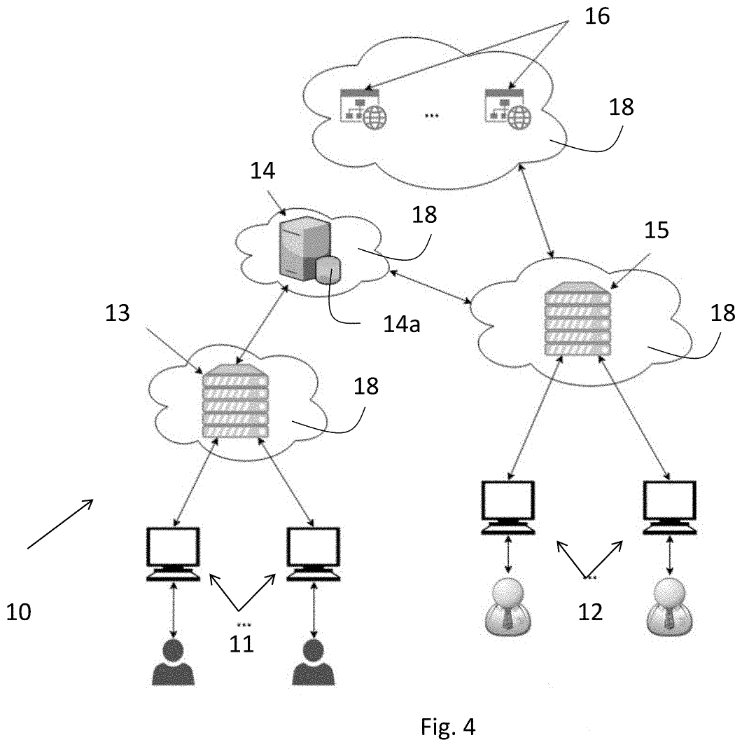

Applicant has verified that, with other state-of-the-art methodologies, which do not provide for semi-automatic tools as provided according to this embodiment, it is not possible to extract some of the information from the above document or from other generic text documents, such as section title pairs (“question” node) and content or answer thereof. The process of creating a Knowledge Base (KB) for chatbot 100 as disclosed and as shown in FIGS. 2 and 3 may be implemented, for example, in a system or system architecture 10 (FIG. 4) comprising at least one server 14, comprising a KB database or repository for chatbot 14a.

The server 14, is connected by way of a geographical network 18, for example by way of an Internet network, to information contents arranged to comprise one or more unstructured or semi-structured textual sources 16, loaded, for example, from databases or file repositories of companies, and to one or more respective KB for chatbot or additional servers 13.

A plurality of operator terminals 12 are connected, by way of the geographic network 18, to a server 15 wherein the package or software packages are provided for applying the process 100 to the unstructured textual sources 16 so as to obtain the respective KB for chatbot 14a stored on the server 14.

The system architecture can be completed, for example, by user terminals 11 configured to access via the geographical network 18 and chatbot software packages, stored for example on additional servers 13, to the KB for chatbot 14a in order to interact, for example, in a natural language with the KB for chatbot 14a.

Software packages to carry out the creation process of a KB for chatbot 100 can be stored on the server 14 or distributed on additional servers 15 or 13.

According to other embodiments, only one server can be provided and the software packages to carry out the process 100 and the chatbot software packages can reside on a single server to which the operator terminals 12 and the user terminals are connected by way of respective BROWSERS and the network 18.

The disclosed process 100 implemented, for example, in the system architecture 10, allows to obtain numerous advantages over the known art.

As a matter of fact, Applicant has noted in numerous tests that the process of creating a KB for chatbot 100 and in particular the extraction process 200 as disclosed, for example in case of extraction of pairs of questions and answers from FAQs comprised in a plurality of WEB pages, allows to achieve excellent results similarly to other known processes but comprises the advantage over the known art of allowing to identify and extract sections of a text, if any.

Indeed, Applicant has noted that, in general, the known art does not provide for identifying and extracting the sections provided within unstructured texts to be processed. This limitation of the known art implies that the question-answer pairs cannot have a hierarchical representation, which is considered very important for applicative aspects. As a matter of fact, the identification and extraction of sections and therefore of the hierarchical representation of the texts allows to show, for example, the question-answer pairs and, in general, the content of a text by highlighting its semantic context of reference.

In summary, in the opinion of the Applicant, the possibility of identifying and extracting sections is a very important functionality which is generally ignored by the prior art compared to the process disclosed here.

Applicant has also noted that in general the prior art does not provide that the extraction process is subject to some mechanism that allows to collect interactions or suggestions from an operator and to apply them so as to try to generalize the extraction process on the basis interactions or suggestions.

Contrary to the known prior art, the process provided, according to the disclosed embodiment, advantageously allows the possibility of having iterations and of reaching 100% coverage and, at each iteration of the extraction process, the possibility of automatically making the best use of the operator suggestions, so as to optimize the process and minimize the number of operator interactions.

Of course, obvious changes and/or variations to the above disclosure are possible, as regards dimensions, shapes, materials, components, circuit elements, connections and contacts, as well as details of circuitry, of the disclosed construction and operation method without departing from the scope of the invention as defined by the claims that follow.

1. A method arranged for extracting and building a Knowledge Base for chatbot starting from an unstructured or semi-structured textual source by using software packages implemented on one or more computers, said method comprising a computer implemented process comprising the steps of
applying to the textual source, encoded in a predetermined encoding language, heuristics and/or a predictive model provided for automatically finding “question” nodes comprised inside the textual source, said step comprising the sub-steps of
generating a tree representative of textual nodes that are comprised inside the textual source,
extracting certain features as more recurring features comprised inside the textual nodes by way of said heuristics and/or predictive model,
selectively assigning to the textual nodes that comprise said certain more recurring features, the feature of “question” nodes, regardless of whether said textual nodes comprise a question mark “?”;
automatically splitting the textual source into sections, if said sections are comprised inside the textual source;
automatically extracting section titles, if said sections are comprised inside the textual source, and answers corresponding to the textual nodes comprising the feature of “question” nodes;
displaying the result of the application of the heuristics and/or predictive model step on an operator terminal;
interactively controlling by way of an operator, by using said operator terminal, the result displayed in the displaying step, and
in case of negative result, manually modifying the displayed result by using operator terminal, or, alternatively,
in case of positive result completing the extraction process, and
storing the KB for chatbot in a database or in a repository.

2. The method according to claim 1, wherein:
said step of automatically splitting the textual source into sections comprises the steps of identifying and grouping into sections one or more groups of “question” nodes on the basis of the “question” nodes found inside the textual source, and said step of automatically extracting section titles and answers comprises the steps of
numbering the found sections in ascending order,
numbering the “question” nodes in ascending number,
recognizing if some “question” nodes are to be considered as respective titles of the found sections; and
assigning to each “question” node, by using as delimiters the “question” nodes and the found sections, an answer wherein each answer is in a direct correspondence with a respective “question” node and assumes the same id.

3. The method according to claim 2, wherein:
said step of automatically extracting section titles and answers comprises the further step of converting by way of an “automatic merging step” the tree representing the text nodes comprised inside the textual source so that the text nodes comprising the feature of “question” node are arranged to comprise a plurality of answers.

4. The method according to claim 1, wherein the step of manually modifying by way of the said operator by using said operator terminal the displayed result, comprises one or more of the following manual operations:
classifying one or more textual nodes by modifying the attributed feature to the textual node made in the step of finding the “question” nodes,
classifying one or more textual nodes stating that said manual classification is a semi-automatic type classification and is applicable to further textual nodes comprising features similar or identical to those of the manual classified textual nodes,
collecting a plurality of answers, unrecognized in the step of automatically finding the “question” nodes, as answers to a single “question” node,
splitting the textual nodes, unrecognized in the step of automatically finding the “question” nodes, into sub-sections of “question” nodes and answers,
eliminating sub-sections erroneously recognized in the step of finding “question” nodes,
correcting the encoding language in which the textual source has been encoded.

5. The method according to claim 2, wherein the step of manually modifying by way of the said operator by using said operator terminal the displayed result, comprises one or more of the following manual operations:
classifying one or more textual nodes by modifying the attributed feature to the textual node made in the step of finding the “question” nodes,
classifying one or more textual nodes stating that said manual classification is a semi-automatic type classification and is applicable to further textual nodes comprising features similar or identical to those of the manual classified textual nodes,
collecting a plurality of answers, unrecognized in the step of automatically finding the “question” nodes, as answers to a single “question” node,
splitting the textual nodes, unrecognized in the step of automatically finding the “question” nodes, into sub-sections of “question” nodes and answers,
eliminating sub-sections erroneously recognized in the step of finding “question” nodes,
correcting the encoding language in which the textual source has been encoded.

6. The method according to claim 3, wherein the step of manually modifying by way of the said operator by using said operator terminal the displayed result, comprises one or more of the following manual operations:
classifying one or more textual nodes by modifying the attributed feature to the textual node made in the step of finding the “question” nodes,
classifying one or more textual nodes stating that said manual classification is a semi-automatic type classification and is applicable to further textual nodes comprising features similar or identical to those of the manual classified textual nodes,
collecting a plurality of answers, unrecognized in the step of automatically finding the “question” nodes, as answers to a single “question” node,
splitting the textual nodes, unrecognized in the step of automatically finding the “question” nodes, into sub-sections of “question” nodes and answers,
eliminating sub-sections erroneously recognized in the step of finding “question” nodes,
correcting the encoding language in which the textual source has been encoded.

7. The method according to claim 1, wherein the step of manually modifying the displayed result is followed by the following steps
an automatic control step arranged for controlling the type of modifications made in the manual modification step, and
if the modifications comprise semi-automatic modifications proceeding with an automatic step wherein
the manual modifications made in the manual modification step are applied to textual nodes comprising features similar or identical to those of the manual classified textual nodes, and
if the modifications comprise explicit modifications recycling the process starting from the step of automatically splitting the textual source into sections, if said sections are comprised inside the textual source.

8. The method according to claim 2, wherein the step of manually modifying the displayed result is followed by the following steps
an automatic control step arranged for controlling the type of modifications made in the manual modification step, and
if the modifications comprise semi-automatic modifications proceeding with an automatic step wherein
the manual modifications made in the manual modification step are applied to textual nodes comprising features similar or identical to those of the manual classified textual nodes, and
if the modifications comprise explicit modifications recycling the process starting from the step of automatically splitting the textual source into sections, if said sections are comprised inside the textual source.

9. The method according to claim 3, wherein the step of manually modifying the displayed result is followed by the following steps
an automatic control step arranged for controlling the type of modifications made in the manual modification step, and
if the modifications comprise semi-automatic modifications proceeding with an automatic step wherein
the manual modifications made in the manual modification step are applied to textual nodes comprising features similar or identical to those of the manual classified textual nodes, and
if the modifications comprise explicit modifications recycling the process starting from the step of automatically splitting the textual source into sections (220), if said sections are comprised inside the textual source.

10. The method according to claim 1, wherein the process comprises an encoding step arranged for encoding unstructured or semi-structured textual sources into HTML encoding language.

11. The method according to claim 2, wherein the process comprises an encoding step arranged for encoding unstructured or semi-structured textual sources into HTML encoding language.

12. The method according to claim 3, wherein the process comprises an encoding step arranged for encoding unstructured or semi-structured textual sources into HTML encoding language.

13. A system configured to implement the method claimed in claim 1, comprising
at least one server comprising one or more software packages configured to extract and create respective Knowledge Base for chatbot from one or more unstructured or semi-structured textual sources,
a database or repository connected
to the at least one server, said database being arranged to store one or more KB for chatbot, and
to one or more unstructured or semi-structured textual sources, by way of a geographical network,
a plurality of operator terminals, connected, by way of the geographic network, to said at least one server and to said one or more unstructured or semi-structured textual sources, configured to enable one or more operators to interact with the one or more software packages comprised in the at least one server.

14. A system configured to implement the method claimed in claim 2, comprising
at least one server comprising one or more software packages configured to extract and create respective Knowledge Base for chatbot from one or more unstructured or semi-structured textual sources,
a database or repository connected
to the at least one server, said database being arranged to store one or more KB for chatbot, and
to one or more unstructured or semi-structured textual sources, by way of a geographical network,
a plurality of operator terminals, connected, by way of the geographic network, to said at least one server and to said one or more unstructured or semi-structured textual sources, configured to enable one or more operators to interact with the one or more software packages comprised in the at least one server.

15. A system configured to implement the method claimed in claim 3, comprising
at least one server comprising one or more software packages configured to extract and create respective Knowledge Base for chatbot from one or more unstructured or semi-structured textual sources,
a database or repository connected
to the at least one server, said database being arranged to store one or more KB for chatbot, and
to one or more unstructured or semi-structured textual sources, by way of a geographical network,
a plurality of operator terminals, connected, by way of the geographic network, to said at least one server and to said one or more unstructured or semi-structured textual sources, configured to enable one or more operators to interact with the one or more software packages comprised in the at least one server.

16. A system configured to implement the method claimed in claim 4, comprising
at least one server comprising one or more software packages configured to extract and create respective Knowledge Base for chatbot from one or more unstructured or semi-structured textual sources,
a database or repository connected
to the at least one server, said database being arranged to store one or more KB for chatbot, and
to one or more unstructured or semi-structured textual sources, by way of a geographical network,
a plurality of operator terminals, connected, by way of the geographic network, to said at least one server and to said one or more unstructured or semi-structured textual sources, configured to enable one or more operators to interact with the one or more software packages comprised in the at least one server.

17. A system configured to implement the method claimed in claim 7, comprising
at least one server comprising one or more software packages configured to extract and create respective Knowledge Base for chatbot from one or more unstructured or semi-structured textual sources,
a database or repository connected
to the at least one server, said database being arranged to store one or more KB for chatbot, and
to one or more unstructured or semi-structured textual sources, by way of a geographical network,
a plurality of operator terminals, connected, by way of the geographic network, to said at least one server and to said one or more unstructured or semi-structured textual sources, configured to enable one or more operators to interact with the one or more software packages comprised in the at least one server.

18. A system configured to implement the method claimed in claim 10, comprising
at least one server comprising one or more software packages configured to extract and create respective Knowledge Base for chatbot from one or more unstructured or semi-structured textual sources,
a database or repository connected
to the at least one server, said database being arranged to store one or more KB for chatbot, and
to one or more unstructured or semi-structured textual sources, by way of a geographical network,
a plurality of operator terminals, connected, by way of the geographic network, to said at least one server and to said one or more unstructured or semi-structured textual sources, configured to enable one or more operators to interact with the one or more software packages comprised in the at least one server.
